(19) United States
(12) Patent Application Publication
(10) Pub. No.: US 2015/0066789 A1
(43) Pub. Date: Mar. 5, 2015

(54) INTERPERSONAL AFFINITY IDENTIFICATION

(71) Applicant: Christopher Keith, New York, NY (US)

(72) Inventor: Christopher Keith, New York, NY (US)

(21) Appl. No.: 14/019,509

(22) Filed: Sep. 5, 2013

(51) Int. Cl. G06Q 50/00; G06Q 10/00

(52) U.S. Cl. CPC G06Q 50/01; G06Q 10/00
USPC 705/319

(57) ABSTRACT

A person, registered at an affinity system, is associated with characteristics describing him/herself, and with at least one set of characteristics describing other persons of interest to the registered person (“desired match descriptions”). The desired characteristics may include that a person is looking for a characteristic. Some of the characteristics may be provided by an expertise system including expertise ratings and rarity ratings. The expertise system determines a characteristic via its own methodology, such as tests or other verifications. The expertise system can be internal or external to the affinity system, and there can be more than one expertise system. When a person checks-in at a location, physically or virtually, the affinity system identifies persons of mutual interest. If each of the registered persons agrees, they both are enabled to contact each other.

### BACKGROUND OF THE INVENTION

The present invention relates to identifying affinity between persons, and more particularly, is directed to comparing a person's characteristics and interests with the characteristics and interests of others to suggest matches to each of the parties.

Search engines have attained tremendous popularity. It is now possible to search within a website, and across multiple websites by keyword, or file characteristic such as image or audio. This search capability has revolutionized information access.

Recent services, sometimes referred to as “location applications”, run on a mobile phone and make it easier for people to connect with each other when they are nearby. People are becoming a domain searched by other people.

Banjo is a mobile application (“app”) that taps into data from Twitter, Foursquare, Instagram and more, and shows a user where people are and what they are saying/doing, based on their check-ins or geotagged tweets. The app also lets a user know when actual friends are nearby, even if they are not on Banjo. People are ranked by distance, not common interests or shared connections.

EchoEcho is a mobile application that uses global positioning system (GPS) data outside then switches to Wi-Fi inside. A user can adjust their visibility on a friend-by-friend basis.

Glancee, founded in 2010, has been acquired by Facebook. According to a video at www.glancee.com, Glancee runs on a smartphone and shows a user who is nearby—general distance, not exact location—and how many friends they have in common. The application shows an image, name, bio, how many friends are in common, and how close (distance) the people are. Glancee automatically records a diary of who was near the user. Glancee sends a notice when someone recommended is nearby, why the person was recommended, and enables sending a message to be sent to the recommended person.

Highlight is a mobile ambient awareness application. When a user comes within a few blocks of another Highlight user who is their Facebook friend or that has common friends or interests, Highlight sends the user a notification and lets the user message the other user. Highlight displays the user's exact location on a map to other users. The app's home screen displays a reverse chronological list of all the people the user has crossed paths with. Highlight has acknowledged that its app does not address the safety/privacy concerns of women.

Ntro (not Intro) is a mobile application that allows a user to filter search results by interest, and set their own top interests narrowly.

Sonar is a mobile application that tells a user when friends and friends' friends are nearby, Sonar uses social and location data from networks like Twitter, Facebook, Foursquare and LinkedIn, to give context about nearby people. As explained in a video at www.sonar.me/about, a user checks in to Sonar, sees nearby venues and who is in each venue and how they are connected to the user (quick description, number of shared Facebook friends and number of shared Twitter friends), sorted by most relevant to the user. Sonar enables a user to send a message to another user to connect. Users can elect to have themselves shown at the top of search lists, for a fee (“pay for promotion”).

SocialRadar is a mobile application in development, and will focus on who is nearby, and how users know each other. For example, it will show people whom a user works with, people a user went to college with, and so on, not just names. The other big differentiator between SocialRadar and the other apps, which often mine publicly available check-in data to find those nearby connections or have disregarded real privacy concerns, is that SocialRadar is meant to offer users more control. Users can choose to share their location with all others, with friends only, or stay anonymous. Users can also control how the app is run, choosing whether or not it is background-enabled. SocialRadar will allow for custom alerts, letting a user tell it when to provide notifications and which people or groups a user is interested in tracking (e.g., when my best friend is nearby, when a fellow fiat brother is in town, when my co-workers are at this event, etc.).

There is room for improvement in automated identifications of persons of potential interest to each other, particularly persons who are not already known to each other.

### SUMMARY OF THE INVENTION

In accordance with an aspect of this invention, there is provided a method of identifying users of interest to each other based on their evaluated expertise. A server computer receives a check-in request for a location from an arriving user.

The server computer determines from other users at the location a set of affinity users for the arriving user, by:
(a) comparing, by the server computer, characteristics of the arriving user with (i) desired characteristics of each of the other users, and (ii) characteristics of each of the other users according to matching rules, to find potential matches;
(b) comparing, by the server computer, characteristics of each of the potential matches with (i) desired characteristics of the arriving user, and (ii) characteristics of the arriving user according to matching rules, to find affinity users;
at least one of the characteristics, of one of the arriving user and the other users, being an expertise evaluation generated by an expertise system.
   The server computer notifies the arriving user of each of the affinity users, and notifies each of the affinity user of the arriving user.

It is not intended that the invention be summarized here in its entirety. Rather, further features, aspects and advantages of the invention are set forth in or are apparent from the following description and drawings.

### BRIEF DESCRIPTION OF THE DRAWINGS

FIG. 1 is a block diagram showing a hardware and communications configuration for the present invention;

FIGS. 2A-2B are a flowchart showing operation of the present invention; and

FIG. 3 is a flowchart showing expertise evaluation.

### DETAILED DESCRIPTION

According to the present invention, a person, registered at an affinity system, is associated with characteristics describing him/herself, and with at least one set of characteristics describing other persons of interest to the registered person (“desired match descriptions”). Some of the characteristics may be provided by an expertise system including expertise ratings and rarity ratings. The expertise system provides a trusted credential for a person via its own methodology, such as tests or other verifications. The expertise system can be internal or external to the affinity system, and there can be more than one expertise system.

The affinity system enables matching based on desired characteristics. For instance, if a user is an accountant, the user can include in their characteristics of persons of interest someone who is looking for an accountant.

The affinity system identifies registered persons of mutual interest by their characteristics, desired match characteristics and default rules of the affinity system, with or without revealing their identity. If each of the registered persons agrees, they both are enabled to contact each other.

It is an important aspect of the present invention that the descriptive data expands and becomes more granular over time, in a non-uniform manner, such that persons having less granular descriptive data are able to interact with persons having more granular descriptive data. The expertise systems expand the scope and granularity of the descriptive data as they are coupled to the affinity system and as people become “accredited” by the various expertise systems.

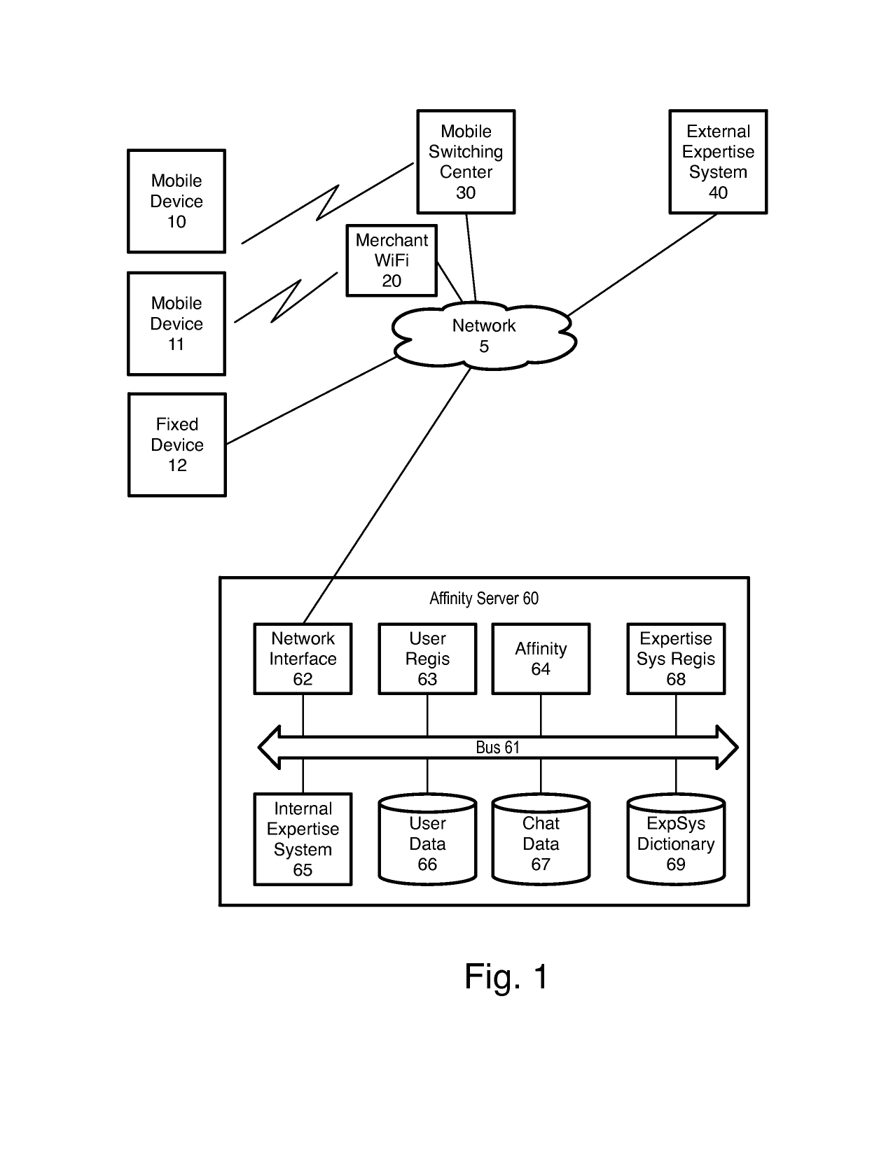

FIG. 1 is a block diagram showing a hardware and communications configuration for the present invention. Network 5 is a digital communication network such as the Internet. A user uses one of mobile device 10 that communicates with network 5 via long-range wireless cellular channel via mobile switching center 30, mobile device 11 that communicates with network 5 via short-range wireless WiFi channel via a WiFi hotspot located at merchant 20, and fixed device 12 that communicates with network 5 via wireline channel, such as a fiber optic cable. For instance, fixed device 12 may be a computer at an Internet cafe. Other communication configurations between the user device and network 5 are also suitable. The user device is one of a computer, smart phone, handheld personal device and so on, able to exchange digital information with network 5.

External expertise system 40 and affinity server 60 are each general purpose computers programmed in accordance with the present invention, and each communicates with network 5 via a suitable wireline or wireless channel.

There many be many instances of each of user devices and external expertise systems. There is one instance of affinity server 60, which may be implemented at multiple physical sites for redundancy, reduction in latency time and so on.

Affinity server 60 includes internal communication bus 61 coupled to each of network interface 62, user registration module 63, affinity module, optional internal expertise system 65, user database 66, affinity database 67, expertise system registration module 68 and expertise system dictionary 69.

Network interface 62 passes information between network 5 and bus 61 in a secure manner such as with firewalls, dedicated ports and so on.

User registration interface 63 enables a user of host 60 to register and update their registration; user database 66 stores the user registrations.

Affinity module 64 is operative to compare user registrations to identify persons of mutual interest, and to enable communication therebetween when both persons agree; affinity database 67 stores the identifications generated by affinity module 64.

Optional internal expertise system 65 functions to accredit a characteristic of a user, and to store the accreditation in user database 66.

As used herein and in the claims, “accredit a characteristic of a user” means to determine via some objective methodology that a user has a characteristic at a particular level or value. The methodology may be administering a test, checking with some other authority that has administered a test, a proprietary methodology, or other suitable methodology.

Expertise system registration module 68 is used by an administrator (not shown) to register a new internal or external expertise system. Registering a new expertise system includes defining data fields created by, and used by, the expertise system, and providing rules used by affinity chat module 64 to process the expertise data.

For example, an expertise system may evaluate the political involvement of a user. Data fields include political party (Democrat, Republican, Independent, Tea Party, John Bircher, and so on), rarity of political party (rare, not rare), political role (elected official, appointed official, government employee, candidate, party activist, substantial funder, interested citizen, non-citizen), rarity of political role (rare, not rare) and level of involvement (full-time, part-time regular, occasional). Rules may include “Democrat not compatible with Republican”, “Tea Party compatible with Republican”, “substantial funder compatible with elected official”, and so on.

A default rule for affinity module 64 is that users are compatible when all field values created by an expertise system are identical. In the example above, the default is compatibility when (political party, political role, level of involvement) are the same for two users. As discussed above, the expertise system provides additional rules for evaluating compatibility or incompatibility.

Another default rule for affinity module 64 is that when users share a rare characteristic, they are likely to be of interest to each other, unless there is a rule specifying they are not compatible. For instance, in the example above, if fundraising is determined to be rare by the political expertise system, fundraisers would be compatible unless one was a Democrat and the other was a Republican.

In some embodiments, a near-match is when users each have a match that has a high enough score to pass a second threshold, but not sufficiently high for the affinity threshold.

External expertise system 40 functions to accredit a characteristic of a user, and to store the accreditation in user database 66.

A user profile includes self-descriptive data, and desirable (or undesirable) characteristics data for other users.

When a user registers with affinity server 60, the user creates a profile, or links to an existing profile on another service, to initially populate the self-description characteristics (descriptive data) of the user's profile. Over time, particularly as the user becomes accredited by more expertise systems, the user's self-description characteristics increase in scope and granularity.

On a field-by-field basis, the user can specify privacy settings for the self-descriptive data in their profile, in two senses. The first sense is whether the data can be used for affinity matching by affinity module 64. The second sense is whether the data can be revealed to another user that affinity module 64 has determined may be compatible with this user. Privacy settings include, for example, “do not use this data for affinity matching”, “data is usable for affinity matching but do not reveal to other users” (useful for, e.g., someone who is interested in romantic dating but does not want this revealed to other users), “data is usable for affinity matching only if other users have the same data” (useful for, e.g., user who has AIDS and is willing for other AIDS users to know this, but otherwise wants to keep this private), “data is usable for all affinity matching and can be revealed to other users”, and so on.

If the user is linking to their social media profile on another site, the default is to use the privacy level specified at the other site; the user can override the default.

During registration, the user provides initial values for the characteristics of other users that the user is interested in, or not interested in. These values can be updated by the user at any time. The user also specifies how interested the user is in meeting such other people. For instance, a female user may specify that she wants to date men, that this characteristic can be used for affinity matching but revealed only to men who are interested in dating women, and that she is “extremely” interested in meeting men aged 25-30, “somewhat” interested in meeting men aged 31-35, “not” interested in meeting men younger than 25, and “not” interested in meeting men older than 35.

During registration, or at any time thereafter, the user can adjust the default parameters for the affinity matching. Parameters include, for example:
A first compatibility threshold for acceptable matches with in-person notices, also referred to as immediate matches or affinity matches. Setting the threshold higher reduces the number of matches, while setting it lower provides more matches;
A second compatibility threshold for acceptable matches with notification only, also referred to as near-matches. That is, the user may be willing to get a notice of a possible match emailed to them;
A maximum number of matches to be shown at any time. In other words, the largest number of matches that can be provided at any time. This is particularly useful when a user checks in at a conference, to show the user only the best matches;
A minimum number of matches to be shown, even if only near-matches;
Whether the potential matches should be saved, and if so, for how long.

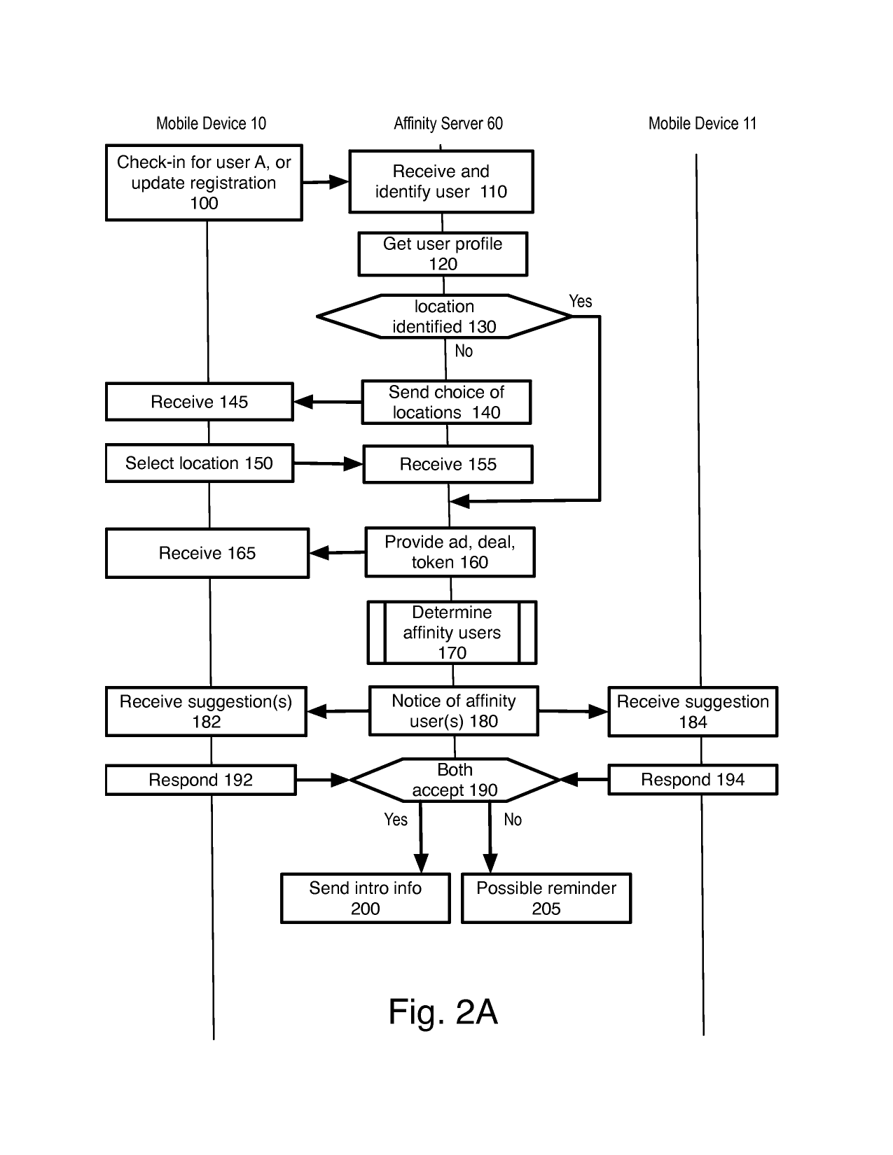

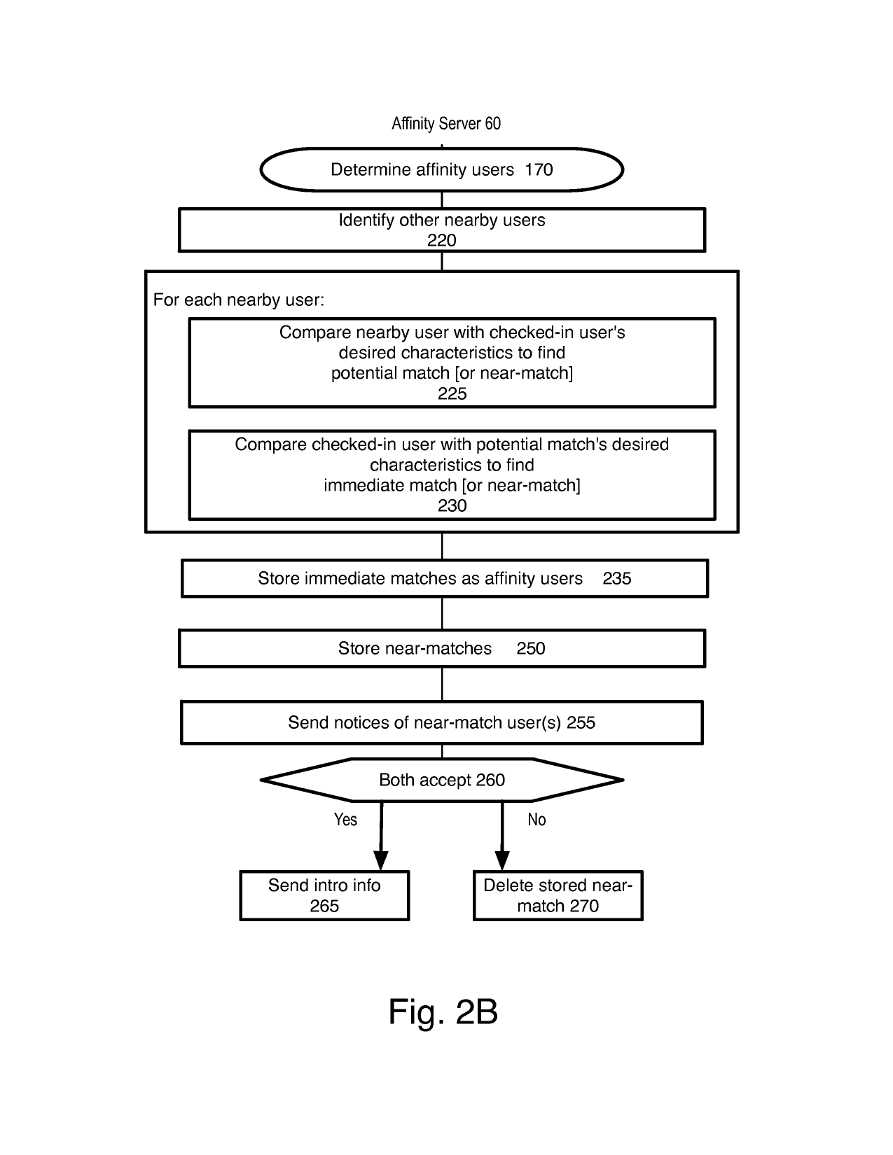

FIGS. 2A-2B is a flowchart showing operation of the present invention.

At step 100 of FIG. 2A, mobile device 10 checks in to a new location, or the user of mobile device 10 updates their registration. In one embodiment, check-in comprises an intentional action of the user such as actuating an icon on mobile device 10. In another embodiment, check-in occurs without an intentional action of the user, such as when the user moves. In yet another embodiment, check-in occurs automatically at predetermined times set by the user. In other embodiments, combinations of these check-in techniques are used. More specifically, check-in comprises sending a message from mobile device 10 to affinity server 60 including (a) a user code, and (b) location data, such as GPS data, automatically obtained by mobile device 10 for creating the check-in message.

In some cases, mobile device 10 uses long-range cellular communication, so the physical space where the user checks-in is not involved in the check-in process. In other cases, mobile device 10 uses short-range communication, such as a Wi-Fi hotspot operated by merchant 20, and the merchant can append its merchant code to the check-in message, which usually helps identify the user's location.

In another embodiment, a user can initiate a “virtual check-in” at a location, although not physically present at the location. This virtual check-in capability enables (i) fixed device 12 to operate as if it were a mobile device, and (ii) a user to simultaneously have a virtual presence in multiple locations.

Check-out occurs via a deliberate user action, such as actuating an icon on mobile device 10. In some embodiments, check-out occurs automatically, such as when the user move a predetermined distance away from the check-in location, or after a predetermined time, or a combination of these techniques.

At step 110, affinity server 60 receives the check-in message and identifies the user.

At step 120, affinity server 60 retrieves the user's profile from user database 66.

At step 130, affinity server 60 decides whether the location of mobile device 10 is unambiguous. Generally, the location of mobile device 10 is determined from the location data that is part of the check-in message. For instance, if the user checks-in at a place separate from other places, then the user's location is probably unambiguous (determinate). However, if the user checks in at a cafe in a multi-story shopping center, the user's location may be ambiguous. If unambiguous, processing continues at step 160.

If affinity server 60 decides that the user's location is ambiguous, at step 140, affinity server 60 sends a menu of locations to mobile device 10, so that the user can select the proper location. At step 145, mobile device 10 receives the locations menu. At step 150, mobile device 10 sends the user's selected location to affinity server 60. At step 155, affinity server receives the user's location selection.

At step 160, affinity server 60 provides information to mobile device 10, typically an advertisement; a “deal” or coupon, usually for a nearby business; and a token that is part of a user rewards type program that is outside the scope of this invention. In some embodiments, step 160 is omitted.

At step 160, affinity module 64 executing on affinity server 60 determines who the affinity users are for the current user. In short, one-by-one, affinity module 64 compares the profile of the user of mobile device 10 with the profiles of the users located in the location of mobile device 10, and when the profile have an affinity matching score exceeding the thresholds specified by both users, the other user is determined to be an affinity user, that is, a compatible match.

Turning to FIG. 2B, at step 220, affinity server 60 identifies other users who are nearby to the user of mobile device 10 (the “newly checked-in” user). In one embodiment, the user of mobile device 10 specifies a distance for “nearby” in their profile. In another embodiment, affinity server 60 considers only those users checked in at the same location to be nearby. In yet another embodiment, affinity server 60 considers the nearest 100 users (or other fixed number, possibly as specified in the profile of the user of mobile device 10) to be nearby.

In embodiments with virtual check-in, users can specify whether to (a) eliminate all “virtual check-in” other users as lacking affinity, (b) rank physically checked-in users higher than virtually checked-in users, or (c) give equal preference to virtually and physically checked-in users.

Steps 225 and 230 are repeated for each nearby user relative to the newly checked-in user.

At step 225, affinity server 60 compares the desired characteristics of the newly checked-in user with the characteristics of the nearby user to find potential matches.

The desired characteristics may be thought of as tuples: (characteristic, value, intensity), where “intensity” is a weighting factor specified by the user, indicating the importance of this factor on a scale of +5 (very desirable) to −5 (very undesirable), or other suitable scale. Characteristic may be a simple characteristic, such as “age”, or a complex characteristic, such as “theater_live & role=actor”. In the former, value=“25-30” specifies an age group. In the latter, value=“amateur” specifies that the desired match has some amateur acting experience. Usually, when a desired characteristic is satisfied, it has a value of “1” weighted (multiplied) by the “intensity”.

The match level is the sum of the weighted desired characteristics matches possibly augmented by affinity rules specified by affinity server 60 and any rules specified by expertise systems. For example, a default affinity rule is that if two users have the same value of a characteristic, there is a match.

In some embodiments, the default affinity rule has a rarity value, that operates similar to the intensity, that is, intensity is specified by a user whereas rarity is specified by affinity server 60. A user can override the default affinity rules by manually specifying an intensity.

In some embodiments, the match level is adjusted for the location of the users, such as by dividing by the distance between users, or other suitable method, typically to give preference to the nearest users.

In some embodiments, a user has a prominence or celebrity value that multiplies their match score.

When the match level exceeds the match threshold specified by the user, then a potential match exists.

At step 230, affinity server 60 compares, for each potentially matching nearby user, their desired characteristics with the characteristics of the newly checked-in user to find if the newly checked-in user meets the criteria of the potential match. When each of the newly checked-in user and a potential match satisfy the other's desired characteristics, there is an immediate match; these two users are referred to as affinity users.

At step 235, the immediate matches are stored. Processing for the immediate matches resumes in FIG. 2A at step 180.

In some embodiments, affinity server 60 now looks for near-matches for the newly checked-in user. An affinity match satisfies the highest thresholds of each user in the matched pair. A near-match satisfies lower thresholds of each user in the matched pair. Notices of near-matches have less priority than those of affinity matches.

At step 250, the near-matches are stored.

At step 255, affinity server 60 sends notices of near-match users to each other, typically via email, and in some embodiments, by activating a “new near match” icon on the display of the mobile devices of the near-match users. Generally, the notices describe characteristics of the users without revealing their name or specific location. It is recommended that users accept or deny near-matches within one day.

At step 260, affinity server 60 determines whether each of a pair of near-match users desire to communicate. If so, processing continues at step 265. If not, processing continues at step 270.

At step 265, affinity server 60 sends a message to each of the near-match users, providing their names, possibly photos, specific location information, and enables them to exchange messages.

At step 270, when it is determined that at least one of a pair of near-match users does not wish to communicate, affinity server 60 deletes the near-match from both near-match users.

Returning to FIG. 2A, at step 180, affinity server 60 sends notices of the existence of the affinity users to mobile device 10, and sends notices of the user of mobile device 10 to the other affinity users. Generally, the notices describe characteristics of the users without revealing their name or specific location; the notice may specify whether a user has virtually or physically checked-in. In some embodiments, a user can provide an image to accompany the match notice, such as a professional headshot for users satisfying the professional desired characteristics, and a sports headshot for users satisfying the sports desired characteristics. It is recommended that users respond to affinity match notices as soon as possible.

At step 182, mobile device 10 receives the notices of affinity users. The user of mobile device 10 can browse the notices, and if desirous of immediately meeting one of the users, so indicate. At step 192, mobile device 10 sends the indication of desired meeting to affinity server 60.

Similarly, at step 184, the affinity users each receive a notice of the user of mobile device 10, and if desirous of immediately meeting, can so indicate. At step 194, mobile device 11 sends the indication of desired meeting to affinity server 60.

In another embodiment, for each affinity user, the user can select from a variety of responses, as shown in Table 1.

TABLE 1

| Response | Meaning |
|---|---|
| Now | I want to chat in-person with this person now, please |
| | notify them of my immediate interest. |
| Email | I want to send an email to this person, but do not want |
| | to meet in person now. |
| Maybe Later | Save this person in my “suggested chats” list, and I |
| | will decide later if I want to email them. |
| Not now | Not interested in chatting with this person, but ok to |
| | suggest them again in future. |
| Never | Never suggest this person to me. |
| Hide Me | Never suggest me to this person and |
| | never suggest this person to me |

At step 190, affinity server 60 determines whether there is a match between users desirous of meeting. If so, processing continues at step 200. If not, processing continues at step 205.

If neither the user of mobile device 10 nor any of the affinity users wish to meet, then processing is complete.

Assume that the users of mobile devices 10 and 11 wish to meet. At step 200, affinity server 60 sends a message to each of mobile devices 10 and 11, providing their names, possibly photos, specific location information, and enables them to exchange messages.

Assume that the user of mobile device 10 wishes to meet the user of mobile device 11, but the user of mobile device 11 does not wish to meet, or vice-versa. At step 205, affinity server 60 provides appropriate reminder information, such as adding the users to each other's agendas, and/or sending a reminder notice.

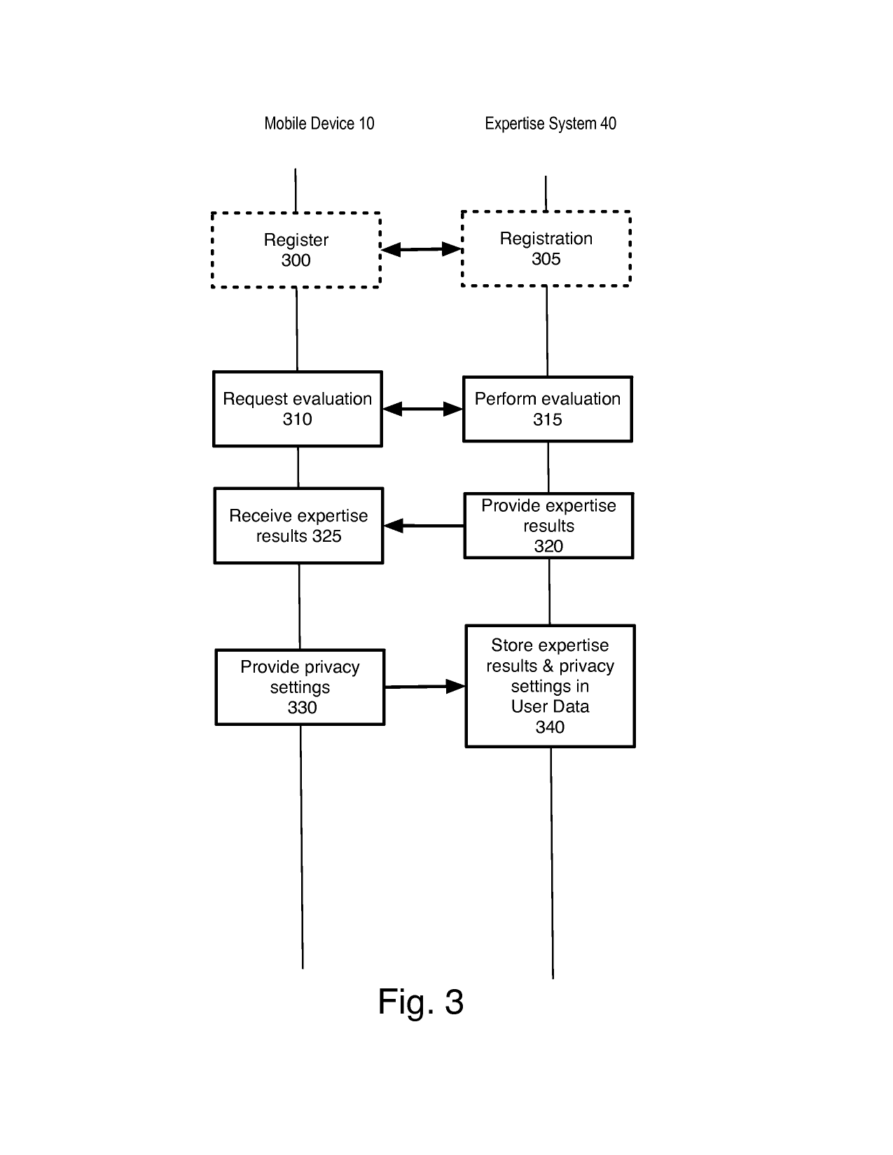

FIG. 3 is a flowchart showing expertise evaluation.

At step 300, a user of mobile device 10 registers at expertise system 40, and at step 3025, expertise system 40 receives the registration. As indicated by dotted lines around step 300, in some embodiments, registration is not necessary. If the expertise system is local to affinity server 60, such as internal expertise system 65, the evaluation proceeds in similar manner, except that registration is unnecessary.

At step 310, the user requests an evaluation of their expertise, such as by taking a timed test, by confirming the existence of a credential such as membership in a professional group or possession of a state license to practice something, by validating their age from their driver's license, or by another type of expertise evaluation.

At step 315, expertise system 40 performs the evaluation of the user's expertise, such as by grading the number of correct answers provided in the timed test, by confirming the existence of a membership or license, by examining the driver's license, or by another suitable action.

At step 320, expertise system 40 provides the expertise results to the user, such as a ranking of expertise on a scale of 1 to 10, or by validating the existence of the membership or license. At step 325, the user receives the results. At step 330, the user specifies the privacy settings for the expertise results. At step 340, expertise system 40 sends the expertise results and privacy settings to affinity server 60 for storage in user data 66.

In some embodiments, a user can search for places having a person meeting certain criteria, and upon finding such a place, the user can check-in to that place, either physically or virtually. For instance, an accountant can search for places having someone seeking an accountant, then virtually check-in, to see if an affinity match is suggested.

### First Use Case

In the first use case, three users sequentially enter a supermarket, and one user is in a cafe 0.25 miles from the supermarket. None of these users has obtained credentials from an expert system. All users have some interest in golf and live plays.

In the second use case, the same four users have obtained credentials from a golf expertise system, and otherwise the situation is similar to the first use case. The second use case illustrates how the expertise system results in different matches.

Turning to the first use case, Table 2 provides profiles of characteristics of the four users, user 10, user 11, user 12, user 13, while Table 3 provides desired characteristics that each of the users has specified for their affinity matches, along with a threshold for matching. All users have provided permission to affinity server 60 to search their social network, and their direct contacts are shown in Table 2. For this use case, only a small number of desired characteristics has been specified; it will be understood that a practical case could have a much larger number of desired characteristics.

TABLE 2

| | User 10 | User 11 | User 12 | User 13 |
|---|---|---|---|---|
| social network | A. Alpha | A. Alpha | B. Beta | G. Gamma |
| direct contacts | B. Beta | D. Delta | D. Delta | E. Epsilon |
| | G. Gamma | E. Epsilon | I. Iota | I. Iota |
| | | M. Mu | | M. Mu |
| Occupation | engineer | lawyer | accountant | president |
| sub-occupation | electrical | divorce, family | firm | owner |
| privacy | public | public | public | public |
| language | English | English | English | English |
| proficiency | native | second | native | second |
| privacy | public | public | public | public |
| language | 0 | French | 0 | French |
| proficiency | | native | | native |
| privacy | | private | | search/ |
| | | | | nondisplay |
| subject | golf | golf | golf | golf |
| role | supplier | player | player | player |
| proficiency | professional | new | retired pro | amateur |
| privacy | public | public | search/ | public |
| | | | nondisplay | |
| subject | golf | 0 | 0 | 0 |
| role | player | | | |
| proficiency | amateur | | | |
| privacy | public | | | |
| subject | live_plays | live_plays | live_plays | live_plays |
| role | audience | actor | producer | investor |
| proficiency | occasional | amateur | amateur | professional |
| privacy | public | public | search/ | search/ |
| | | | nondisplay | nondisplay |

TABLE 3

| | User 10 | User 11 | User 12 | User 13 |
|---|---|---|---|---|
| threshold | 8 | 11 | 10 | 15 |
| Occupation | accountant | | | |
| sub-occupation | any | | | |
| interest | 5 | | | |
| language | | French | | |
| proficiency | | speaking | | |
| interest | | 5 | | |
| subject | | golf | live_plays | golf |
| role | | player | investor | player |
| proficiency | | any | any | professional |
| interest | | 5 | 4 | 5 |

Some helpful facts, reflected in Table 3:
user 10 is an owner of a golf supplies business, and is looking for a new accountant;
user 11 has just started playing golf, and wants to find others to play with, particularly golfers who also speak French;
user 12 sometimes produces live plays for a community group, and is interested in finding investors; and
user 13 is an excellent amateur golfer and is interested in golfing with a professional.

Table 4 shows the default matching rules used by affinity server 60.

TABLE 4

| | |
|---|---|
| Rule 01 | If two users have the same (subject, role, proficiency), there is |
| | an attribute match having value 10. |
| Rule 02 | If two users have the same (subject, role), there is an attribute |
| | match having value 3. |
| Rule 03 | If two users have the same (subject), there is an attribute match |
| | having value 1. |
| Rule 04 | If two users know the same person, there is an attribute match |
| | having value 5. |

Affinity server 60 derates (makes less attractive) users who are further away. In this use case, to be considered “nearby” a user must be within two miles of another user. The derating is accomplished by multiplying the raw affinity score by 1/(1+d) where d is the distance in miles between two users. In this use case, the supermarket is 0.25 miles from the cafe, so the distance derating factor, when one user is in the cafe and the other is in the supermarket, is 1/(1+0.25)=4/5=80%.

To begin the use case, user 13 checks in at a cafe. Let it be assumed that there are no nearby checked-in users.

Next, user 12 checks in at the supermarket.

Affinity server 60 determines that user 13 is a nearby user, since user 13 is at the cafe that is 0.25 miles from the supermarket. The distance derating factor is 1/(1+0.25)=4/5.

In phase one, affinity server 60 determines whether user 13 is a good match for user 12. The raw affinity score is the sum of the desired characteristics affinity, plus default rules, plus social networking:
User 12 is looking for a live_plays investor. User 13 is a live_plays investor, so there is a match. User 12's desired characteristics specifies that a match has a value of 4.
Rule 02 says that users having the same (subject, role) result in a match value of 3. Here, users 12 and 13 are both golf players.
Rule 03 says that users having the same (subject) result in a match value of 1. Here, users 12 and 13 both have (live_plays).
Rule 04 says that a common social network contact results in a match value of 5. Here, users 12 and 13 both know I. Iota.
   Thus, the raw affinity score for user 13 relative to user 12's desired characteristics is 4+3+1+5=13. The distance derated affinity score is 13*4/5=10.4. User 12's affinity threshold is 10. Since 10.4>10, user 13 is a good match for user 12.

In phase two, affinity server 60 determines whether user 12 is a good match for user 13. User 12 does not meet any of user 13's desired characteristics, since user 13 is looking for a golf professional, while user 12 is merely a retired golf professional. Otherwise, the scoring is as above, resulting in a raw affinity score of 0+3+1+5=9, and a derated affinity score of 9*4/5=7.2. Since user 13's affinity threshold is 15 (a high threshold corresponds to being very selective about meetings), user 12 is not a good match for user 13.

Since users 12 and 13 are not mutually compatible, no affinity match exists.

Next, user 11 checks in at the supermarket.

Affinity server 60 determines that user 12 is a nearby user, since user 12 is also at the supermarket. The distance derating factor is 1/(1+0)=1, that is, no distance derating.

Affinity server 60 also determines that user 13 is a nearby user, since user 13 is at the cafe that is 0.25 miles from the supermarket. The distance derating factor is 1/(1+0.25)=4/5.

In similar fashion as above, affinity server 60 executes phase one of the user 11 to user 12 comparison:
User 11 is looking for a golf player of any proficiency. User 12 is a golf player, so there is a match. User 11's desired characteristics specifies that a match has a value of 3.
Rule 02 says that users having the same (subject, role) result in a match value of 3. Here, users 11 and 12 are both golf players.
Rule 03 says that users having the same (subject) result in a match value of 1. Here, users 11 and 12 both have (live_plays).
Rule 04 says that a common social network contact results in a match value of 5. Here, users 11 and 12 both know D. Delta.
   Thus, the raw affinity score for user 12 relative to user 11's desired characteristics is 3+3+1+5=12. The distance derated affinity score is 12*1=12. User 11's affinity threshold is 11. Since 12>11, user 12 is a good match for user 11.

In phase two, affinity server 60 determines whether user 11 is a good match for user 12. User 11 does not meet any of user 12's desired characteristics. Otherwise, the scoring is as above, resulting in a raw affinity score of 0+3+1+5=9, and a derated affinity score of 9*1=9. Since user 12's affinity threshold is 10, user 11 is not a good match for user 12.

Since users 11 and 12 are not mutually compatible, no affinity match exists.

In similar fashion as above, affinity server 60 executes phase one of the user 11 to user 13 comparison:
User 11 is looking for a golf player of any proficiency. User 13 is a golf player, so there is a match. User 11's desired characteristics specifies that a match has a value of 3.
User 11 is looking for a French speaker. User 13 is a French speaker, so there is a match. User 11's desired characteristics specifies that a match has a value of 5.
Rule 02 says that users having the same (subject, role) result in a match value of 3. Here, users 11 and 12 are both golf players.
Rule 03 says that users having the same (subject) result in a match value of 1. Here, users 11 and 12 both have (live_plays).
Rule 04 says that a common social network contact results in a match value of 5. Here, users 11 and 12 both know E. Epsilon and M. Mu, receiving a value of 5 for each contact.
   Thus, the raw affinity score for user 13 relative to user 11's desired characteristics is 3+5+3+1+5+5=22. The distance derated affinity score is 22*4/5=17.6. User 11's affinity threshold is 11. Since 17.6>11, user 13 is a good match for user 11.

In phase two, affinity server 60 determines whether user 11 is a good match for user 13. User 11 does not meet any of user 13's desired characteristics. Otherwise, the scoring is as above, resulting in a raw affinity score of 0+3+1+5+5=14, and a derated affinity score of 14*4/5=11.3. Since user 13's affinity threshold is 15, user 11 is not a good match for user 13.

Since users 11 and 13 are not mutually compatible, no affinity match exists.

Finally, user 10 checks in at the supermarket.

Affinity server 60 determines that users 11 and 12 are nearby, since they are also at the supermarket. The distance derating factor is 1/(1+0)=1, that is, no distance derating.

Affinity server 60 also determines that user 13 is a nearby user, since user 13 is at the cafe that is 0.25 miles from the supermarket. The distance derating factor is 1/(1+0.25)=4/5.

The user 10 to user 11 comparison by affinity server 60 has a phase one in which user 11 does not meet any of user 10's desired characteristics, but they both are golf players, are interested in live_plays, and know A. Alpha. So, the raw affinity score is 0+3+1+5=9, and a derated affinity score of 9*1=9. Since user 10's affinity threshold is 8, user 11 is a good match for user 10.

Phase two of the user 10 to user 11 comparison determines that user 10 meets the golf player desired characteristic of user 11, resulting in a match score of 3. Otherwise, the analysis is as above, resulting in a raw affinity score of is 3+3+1+5=12, and a derated affinity score of 12*1=12. Since user 11's affinity threshold is 10, and 12>10, user 10 is a good match for user 11.

Users 10 and 11 are mutually compatible, that is, an affinity match exists. Accordingly, as in FIG. 2A, step 180, affinity server 60 sends a notice alert to each of users 10 and 11, such as “AFFINITY MATCH. User nn is 0.0 miles from you. Do you want to communicate?” In some embodiments, the notice alert contains information, such as the factors that resulted in the user's affinity threshold being exceeded (unless the other user has specified that the factor is not to be displayed), or a general description of the other user, such as occupation, photo or whatever the other user wishes to have revealed in a notice alert to affinity matches. As in FIG. 2A, steps 190-200, if both users want to communicate, then affinity server 60 sends introduction information such as their phone numbers, or other suitable contact means.

The user 10 to user 12 comparison by affinity server 60 has a phase one in which user 12 meet user 10's desired characteristic of being an accountant which has a match value of 5, and they both are golf players, are interested in live_plays, and know B. Beta. So, the raw affinity score is 5+3+1+5=14, and a derated affinity score of 14*1=14. Since user 10's affinity threshold is 8, user 12 is a good match for user 10.

Phase two of the user 10 to user 12 comparison determines that user 10 does not meet any desired characteristic of user 12. Otherwise, the analysis is as above, resulting in a raw affinity score of is 0+3+1+5=9, and a derated affinity score of 9*1=9. Since user 12's affinity threshold is 10, user 10 is not a good match for user 11. User 12 has lost a possible business engagement—this may be fine if user 12 is not looking for more business. The use case below illustrates what user 12 would have had to do to enable this chance to connect with user 10.

Since users 10 and 12 are not mutually compatible, no affinity match exists.

The user 10 to user 13 comparison by affinity server 60 has a phase one in which user 13 does not meet any of user 10's desired characteristics, but they both are golf players, are interested in live_plays, and know G. Gamma. So, the raw affinity score is 0+3+1+5=9, and a derated affinity score of 9*4/5=7.2. Since user 10's affinity threshold is 8, user 13 is not a good match for user 10, and there is no reason to continue to phase two.

Since users 10 and 13 are not mutually compatible, no affinity match exists.

### Second Use Case

Assume the same scenario as above, except that user 12, an accountant, wants to meet people desiring an accountant. Table 5 is similar to Table 3, except Table 5 reflects user 12's desire to meet people seeking an accountant.

TABLE 5

| | User 10 | User 11 | User 12 | User 13 |
|---|---|---|---|---|
| threshold | 8 | 11 | 10 | 15 |
| Occupation | accountant | | seeks accountant | |
| sub-occupation | any | | any | |
| interest | 5 | | 9 | |
| language | | French | | |
| proficiency | | speaking | | |
| interest | | 5 | | |
| subject | | golf | live_plays | golf |
| role | | player | investor | player |
| proficiency | | any | any | professional |
| interest | | 3 | 4 | 5 |

The affinity matching proceeds as described for the first use case, except when evaluating whether users 10 and 12 are a match. It will be recalled that user 12 is a good match for user 10. Now, in phase two, evaluating whether user 10 is a good match for user 12, the fact that user 10 is seeking an accountant yields a match value of 9, and a raw affinity score of is 9+3+1+5=18, and a derated affinity score of 18*1=18. Since user 12's affinity threshold is 10, user 10 is a good match for user 11.

Now, users 10 and 11 are mutually compatible, that is, an affinity match exists. As described above, affinity server 60 sends a notice alert to both users 10 and 11.

### Third Use Case

Assume the same scenario as in the first use case, except that users 10, 12 and 13 have chosen to get their golf expertise certified by golf expertise system 40.

Also assume that when golf expertise system 40 was registered with affinity server 60, via expertise system registration module 68, a new subject “golf_exp” was created, with “golf_exp” roles being one of (golf_exp_player, golf_exp_instructor, golf_exp_professional), and proficiency being a number between 1 and 10,000. Also, new matching rules are created, that when two users have a golf_exp proficiency within 50 points of each other, then there is an attribute match having value 6; and when two users have a golf_exp proficiency within 100 points of each other, then there is an attribute match having value 4. Table 6 is similar to Table 4, except Table 6 reflects these new rules.

TABLE 6

| | |
|---|---|
| Rule 01 | If two users have the same (subject, role, proficiency), there is |
| | an attribute match having value 10. |
| Rule 02 | If two users have the same (subject, role), there is an attribute |
| | match having value 3. |
| Rule 03 | If two users have the same (subject), there is an attribute match |
| | having value 1. |
| Rule 04 | If two users know the same person, there is an attribute match |
| | having value 5. |
| Rule 05 | If golf_exp_proficiency of other user is + or − 50 relative |
| | to current user, there is an attribute match having value 6. |
| Rule 06 | If golf_exp_proficiency of other user is + or − 100 relative |
| | to current user, there is an attribute match having value 4. |

It is an important aspect of the present invention that the expertise evaluations of golf expertise system 40 are usable by affinity server 60 in finding affinity matches, although affinity server 60 is utterly ignorant as to how golf expertise system 40 conducts its expertise evaluations.

Table 7 is similar to Table 2, except that it shows the golf_exp expertise certifications of users 10, 12, 13.

TABLE 7

| | User 10 | User 11 | User 12 | User 13 |
|---|---|---|---|---|
| social network | A. Alpha | A. Alpha | B. Beta | G. Gamma |
| direct contacts | B. Beta | D. Delta | D. Delta | E. Epsilon |
| | G. Gamma | E. Epsilon | I. Iota | I. Iota |
| | | M. Mu | | M. Mu |
| Occupation | engineer | lawyer | accountant | president |
| sub-occupation | electrical | divorce, family | firm | owner |
| privacy | public | public | public | public |
| language | English | English | English | English |
| proficiency | native | second | native | second |
| privacy | public | public | public | public |
| language | 0 | French | 0 | French |
| proficiency | | native | | native |
| privacy | | private | | search/nondisplay |
| subject | golf | golf | golf | golf |
| role | supplier | player | player | player |
| proficiency | professional | new | retired pro | amateur |
| privacy | public | public | search/nondisplay | public |
| subject | golf | 0 | 0 | 0 |
| role | player | | | |
| proficiency | amateur | | | |
| privacy | public | | | |
| subject | golf_exp | 0 | golf_exp | golf_exp |
| role | golf_exp_player | | golf exp_player | golf_exp_player |
| proficiency | 330 | | 3600 | 152 |
| privacy | public | | search/nondisplay | public |
| subject | live_plays | live_plays | live_plays | live_plays |
| role | audience | actor | producer | investor |
| proficiency | occasional | amateur | amateur | professional |
| privacy | public | public | search/nondisplay | search/nondisplay |

Table 8 is similar to Table 3, except that is shows the golf_exp desired characteristics of users 10, 12, 13, beyond the defaults of Rules 05 and 06. For this use case, the only additional desired characteristic is that user 13 is seeking someone with a golf_exp proficiency of at least 500, that is, definitely a better player than user 13.

TABLE 8

| | User 10 | User 11 | User 12 | User 13 |
|---|---|---|---|---|
| threshold | 8 | 11 | 10 | 15 |
| Occupation | accountant | | | |
| sub-occupation | any | | | |
| interest | 5 | | | |
| language | | French | | |
| proficiency | | speaking | | |
| interest | | 5 | | |
| subject | | golf | live_plays | golf |
| role | | player | investor | player |
| proficiency | | any | any | professional |
| interest | | 3 | 4 | 5 |
| subject | | | | golf_exp |
| role | | | | golf_exp_player |
| proficiency | | | | at least 500 |
| interest | | | | 33 |

The affinity matching proceeds as described for the first use case, except as described below. Since the golf_exp_proficiency scores of users 10, 12, 13 are 330, 3600, 152, respectively, new Rules 05 and 06 are not triggered.

When user 12 checks in at the supermarket, the evaluation of user 12 relative to user 13 is unchanged (since 10.4>10, user 13 is a good match for user 12). However, user 13 is seeking someone with a golf_exp_proficiency of at least 500, and user 12's golf_exp_proficiency is 3600, so there is a match value of 33 (user 13 must be quite interested in finding a good golf player), resulting in a raw affinity score of 33+3+1+5=42, and a derated affinity score of 42*4/5=33.6. Since user 13's affinity threshold is 15, and 33.6>15, user 12 is a good match for user 13.

Now, users 12 and 13 are mutually compatible, that is, an affinity match exists. As described above, affinity server 60 sends a notice alert to both users 12 and 13.

Although an illustrative embodiment of the present invention, and various modifications thereof, have been described in detail herein with reference to the accompanying drawings, it is to be understood that the invention is not limited to this precise embodiment and the described modifications, and that various changes and further modifications may be effected therein by one skilled in the art without departing from the scope or spirit of the invention as defined in the appended claims.

What is claimed is:

1. A method of identifying users of interest to each other based on their evaluated expertise, comprising:
receiving, at a server computer, a check-in request for a location from an arriving user;
determining, by the server computer, from other users at the location a set of affinity users for the arriving user, by:
(a) comparing, by the server computer, characteristics of the arriving user with (i) desired characteristics of each of the other users, and (ii) characteristics of each of the other users according to matching rules, to find potential matches;
(b) comparing, by the server computer, characteristics of each of the potential matches with (i) desired characteristics of the arriving user, and (ii) characteristics of the arriving user according to matching rules, to find affinity users;
at least one of the characteristics, of one of the arriving user and the other users, being an expertise evaluation generated by an expertise system;
notifying, by the server computer, the arriving user of each of the affinity users; and
notifying, by the server computer, each of the affinity user of the arriving user.

2. The method of claim 1, wherein the check-in request is from an arriving user that is physically at the location.

3. The method of claim 1, wherein the check-in request is from an arriving user that wishes to be virtually at the location.

4. The method of claim 1, wherein the determining is also based on other users near the location.

5. The method of claim 1, wherein one of the desired characteristics, of one of the arriving user and the other users, is that someone with a particular characteristic is sought.

6. The method of claim 1, further comprising sending, by the server computer, contact information to each of the arriving user and one of the affinity users when each of the arriving user and the one of the affinity users has indicated interest in the other of the arriving user and the one of the affinity users.

7. The method of claim 1, wherein at least one of the matching rules was provided to the server computer from the expertise system.

8. The method of claim 1, wherein the expertise system is operative on the server computer.

9. The method of claim 1, wherein the expertise system is operative on an expertise computer different than the server computer.

10. The method of claim 1, further comprising sending, by the server computer, a deal offer to the arriving user after receiving the check-in request from the arriving user.

11. The method of claim 1, wherein characteristics of each of the arriving user and the other users are stored in respective profiles, and each characteristic has a respective adjustable privacy setting.

12. The method of claim 1, wherein desired characteristics of each of the arriving user and the other users are stored in respective profiles, and each desired characteristic has a respective adjustable interest weighting setting.
